(19) United States
(12) Patent Application Publication
(10) Pub. No.: US 2021/0269152 A1
(43) Pub. Date: Sep. 2, 2021

(54) DISTRIBUTED ELECTRIC ENERGY PODS NETWORK AND ASSOCIATED ELECTRICALLY POWERED VEHICLE

(71) Applicant: H3 Dynamics Holdings Pte. Ltd., Singapore (SG)

(72) Inventors: Taras Wankewycz, Singapore (SG); Bertrand Gauthier, Paris (FR)

(21) Appl. No.: 17/255,192

(22) PCT Filed: Jun. 27, 2019
(86) PCT No.: PCT/IB2019/055425

§ 371 Date: Dec. 22, 2020

(30) Foreign Application Priority Data
Jun. 27, 2018 (FR) 18/70757

(51) Int. Cl. B64C 39/02; B64D 27/24; B64D 29/02; B64D 41/00; B64C 11/00; B60L 8/00; B60L 50/75; B64D 31/00; B60L 58/40; H01M 10/46; H01M 16/00

(52) U.S. Cl. CPC B64C 39/024; H02S 99/00; B64D 29/02; B64D 41/00; B64C 11/00; B60L 8/003; B60L 50/75; B64D 31/00; B60L 58/40; H01M 10/465; H01M 16/006; B64D 2041/005; B60L 2200/10; B64D 2221/00; B64C 2201/042; B64C 2201/165; H01M 2220/20; H01M 2250/20; B64D 27/24

(57) ABSTRACT

The application provides a pod for moving a vehicle and also provides a network of interchangeable pods. The pod includes an energy storage and powering machine and a nacelle. Refer-ring to the nacelle, it includes an enclosure for surrounding the energy storage and powering machine and a joining structure for attaching the enclosure to the vehicle. Referring to the energy storage and powering machine, it includes a power generation module, a propulsion module, and an electronics module. The propulsion module includes an electric motor with a propeller module. The electronics module is provided for activating the power generation module to provide electrical energy to the electric motor, wherein the electric motor actuates the propeller module for moving the vehicle.

The present application relates to an external pod for a vehicle and to a vehicle with a network of pods.

U.S. Pat. No. 9,845,158 B2 shows a battery containment pod. The pod includes a body that is formed of a lightweight material. The body has an aerodynamic exterior shape and has an interior cavity formed in the lightweight material. The size and shape of the interior cavity are designed to accommodate one or more battery packs. A smooth exterior coating covers the exterior shape of the body. An attachment structure is formed in or on the body for allowing the body to be coupled to a flight vehicle.

US 20120160957 A1 shows an external pod for an aircraft.

It is an object of this application to provide an improved pod for a vehicle, such as an aircraft.

The vehicle can refer to, though is not limited to, an electric unmanned aerial vehicle (UAV), an electrically powered aircraft, an electric vertical take-off and landing (VTOL) flying passenger car, and a UAV that can operate in air, on land, or underwater.

It is believed that a network of interchangeable distributed external hydrogen fuel cell/battery hybrid electrical energy systems containment pods, also called as Distributed Electric Energy Pod (DEEP) can be used to support multiple improved vehicle designs, such as aircraft designs.

The distributed electric energy pods are also called interchangeable external hydrogen fuel cell/battery hybrid electrical energy system containment pods, or fuel cell/battery pods for short.

The network of interchangeable distributed external hydrogen fuel cell/battery hybrid electrical energy systems containment pods enables smart and efficient power generation architectures for different vehicle platforms, which in return yields an improved vehicle concept. The fuel cell/battery hybrid based distributed electric energy pods can be utilised as multiple systems in parallel, that is multiple pods operated in parallel, or as a single powering system to move and power an electrically powered vehicle.

The network of distributed electric energy pods also provides an enhanced power generation architecture for a vehicle with electric propulsion. The electric propulsion reduces the overall power required to move the vehicle. By combining of different sources of electric power with different technologies having different corresponding benefits and characteristics, in terms of specific energy, electrical current density, weight, and high efficiency, the network of distributed electric energy pods allows the vehicle to have extended operational flying range and extended operational flight autonomy as well as having greater part redundancy and back-up power sources to improve safety. Moreover, the network of distributed electric energy pods allows electrical flying solutions to reduce noise and carbon emissions as compared to vehicle designs with an internal combustion engine.

The application provides an interchangeable, distributed external hydrogen fuel cell/battery hybrid electrical energy systems containment pod for moving and propelling a vehicle, such as an aircraft, while the vehicle is in flight or on the ground.

The pod includes a nacelle and an energy storage and powering machine.

The nacelle comprises an enclosure for surrounding the energy storage and powering machine and a vehicle joining structure.

In detail, the enclosure is streamlined to allow the enclosure to move easily through the air. Put different, the shape of the enclosure is adapted for reduced drag.

The joining structure is attached to the enclosure for fixing the enclosure to a part of the vehicle, such as a wing, a body, or a fuselage of the vehicle. The wing refers to a horizontal structure that sticks out from a side of the body of the vehicle. The wing supports the vehicle when the vehicle is flying.

The joining structure can attach the enclosure to an external part of the wing or attach the enclosure to the wing such that the enclosure forms a part of the wing. Similarly, the joining structure can attach the enclosure to an external part of the body or attach the enclosure to the body such that the enclosure forms a part of the body.

This attachment is also done such that the pod can be removed easily and quickly from the vehicle. This is useful when the pod needs to be replaced.

Referring to the energy storage and powering machine, it includes a power generation module, a propulsion module, and an electronics module.

The propulsion module includes an electric motor with a propeller module, wherein the electric motor is connected to the propeller module.

In use, the electronics module activates the power generation module, wherein the power generation module provides electrical energy to the electric motor.

The energised electric motor then moves and rotates blades of the propeller module, wherein the rotating blades draw air for moving the vehicle.

The pod is useful in that different numbers of the pod can be attached to the vehicle according to the power requirement of the vehicle. The pod can also be removed easily or quickly from the vehicle for maintenance or replacement of the pod when the pod is spent. In short, the pod can be utilised by the vehicle in different ways, according to the size, weight, and power requirement of the vehicle.

According to one aspect of the application, the power generation module includes a fuel cell stack with an energy storage module, and/or a hybrid battery pack.

In use, the fuel cell stack, together with the energy storage module, supplies electrical energy to the parts of the pod. In detail, the energy storage module provides hydrogen gas to the fuel cell stack, wherein the fuel cell stack uses the hydrogen gas to generate electrical energy and to transmit the generated electrical energy to the vehicle, namely to the electric motor of the propulsion module of the vehicle.

The hybrid battery pack also supplies electrical energy to the electric motor.

Operationally, the power generation module provides two operating modes, namely a standalone mode and a hybrid mode. In the standalone mode, the electronics module activates either the fuel cell stack with the energy storage module or the hybrid battery pack to supply electrical energy to the electric motor. In the hybrid mode, the electronics module activates both the fuel cell stack with the energy storage module and the hybrid battery pack to supply electrical energy to the electric motor.

The hybrid battery pack can include different parts. It can include a lithium polymer (LiPo) battery, or a super-capacitor, or an air-breathing battery, or other chemical energy storage technology, or combinations of the earlier-mentioned parts.

Referring to the propeller module, it can include one or more propellers or one or more electric ducted fans (EDF).

The electronics module often includes an embedded processor, at least one health monitoring sensor, and/or an electrical and communication connectivity unit. In use, the health monitoring sensor measures a characteristic of the pod, such as temperature and later sends the measurement to the embedded processor. The embedded processor then generates an environmental control signal according to the measurement of the health monitoring sensor. After this, the embedded processor sends the signal via the electrical and communication connectivity unit for adjusting an environmental characteristic of the enclosure.

The pod often includes a heat control module for controlling an internal temperature of the enclosure of the nacelle. In use, the pod is often subjected to extreme temperatures. The heat control module then controls and adjusts the enclosure internal temperature to ensure that parts within the enclosure are operating within a predetermined operating temperature range.

The heat control module can include a thermal isolation material, and a ram air circulating device, and/or a heat recovering system. In use, the thermal isolation material acts to shield parts within the enclosure from external extremely high or low temperature. The ram air circulating device is provided for circulating air within the enclosure for cooling equipment that is placed inside the enclosure. The heat recovering system is used for transferring heat into the enclosure to prevent the temperature within the enclosure from falling below a predetermined lower limit temperature.

The pod can include an electrical connector for receiving energy from an external power source.

In one implementation, the external power source comprises a solar power source, such as solar panels being mounted on top of the vehicle for receiving sunlight.

In another implementation, the external power source refers to an energy source of another pod. This energy source provides electrical power to supplement the energy supply of the present pod.

Different configurations of attaching the pod to the vehicle are shown below.

The application provides an improved vehicle, such as an aircraft. The vehicle includes two wings and one or more of the above-mentioned pods. The pod is attached to the respective wing.

The vehicle often includes even number of pods. The pods are also often distributed such that vehicle is aerodynamically balanced.

The application provides a further vehicle. The vehicle includes a body or a fuselage, and one or more of the above pods, wherein each pod is attached to the body.

The vehicle often includes a centralized energy management unit. The centralized energy management unit is provided for activating the pod to supply electrical energy to a propulsion module of the pod.

In a case wherein the vehicle has more than one pod, the centralized energy management unit often activates the pods such that the pods provide an even distribution of electrical energy. As an example, the vehicle can include two pods. The centralized energy management unit activates each pod such that each pod supplies the same amount of electrical energy.

The application provides another vehicle. The vehicle includes two wings, a body or a fuselage, at least one of the above-mentioned first pod, and at least one of the above-mentioned second pod. The first pod is attached to a part of the wing while the second pod is attached to a part of the body.

The vehicle often includes an energy management unit for activating the first pod to provide electrical energy to a first propulsion module of the first pod and for activating the second pod to provide electrical energy to a second propulsion module of the second pod.

The activation can be done such that each pod provides the same amount of electrical energy.

The application also provides a method of providing electrical power to a vehicle.

The method includes a step of attaching one or more pods to wings or to a body or fuselage of the vehicle. Each pod contains a hydrogen fuel cell, a hybrid battery and a propulsion module.

After this, one member of a group of each pod is activated to provide electrical power to the propulsion module. The group consisting of the hydrogen fuel cell, the hybrid battery, and a combination of the hydrogen fuel cell and the hybrid battery of each pod. In other words, the hydrogen fuel cell, or the hybrid battery, or both the hydrogen fuel cell and the hybrid battery are then activated to provide electrical power to the propulsion module.

In one aspect of the application, the attaching of the pods to the vehicle includes a step of attaching two or more pods to the vehicle.

The activating of the two or more pods can be performed such that the pods provide an even distribution of electrical power to the vehicle. In other words, each pod is activated to provide the same amount of electrical power to the vehicle.

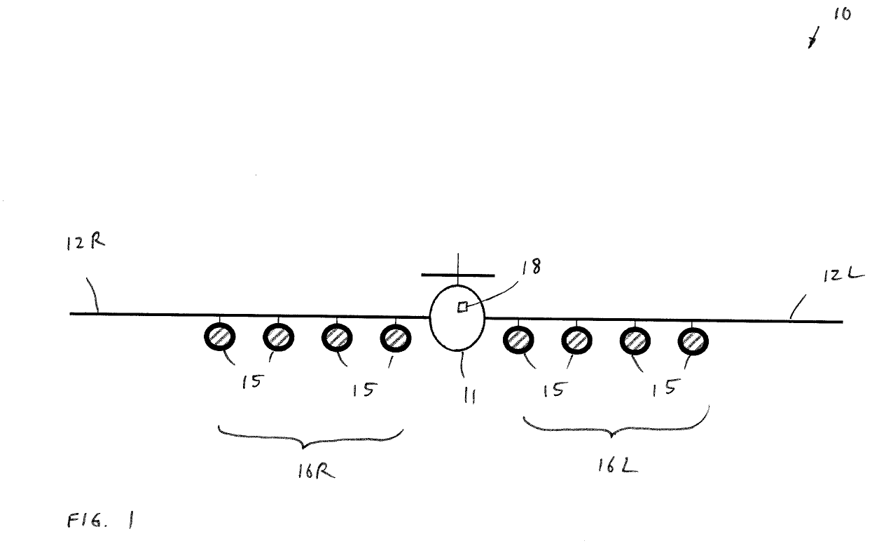

FIG. 1 illustrates a front cross-sectional view of an improved aircraft that includes distributed electric energy pods that are arranged in a network configuration,

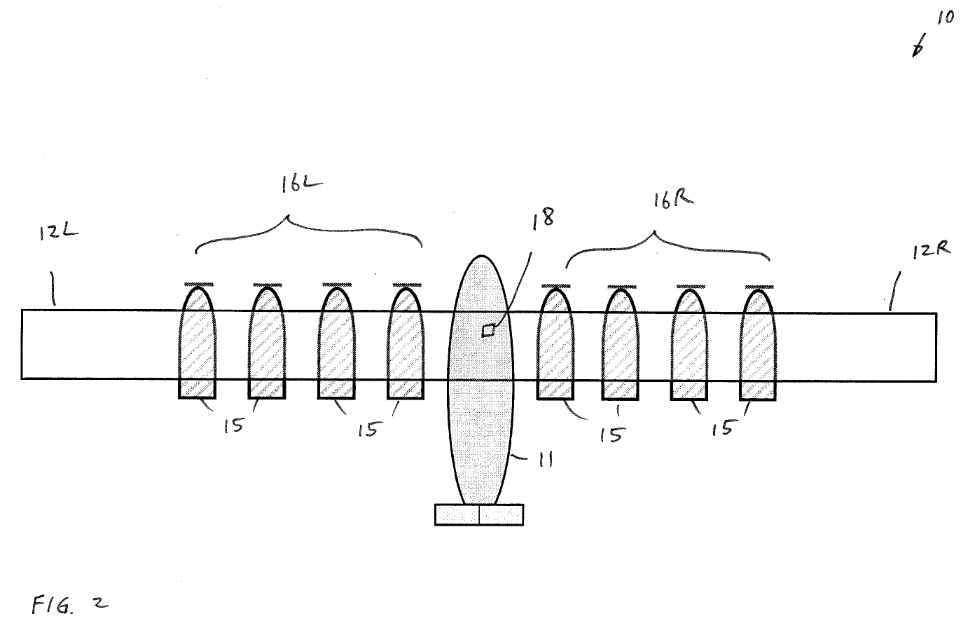

FIG. 2 illustrates a top view of the aircraft of FIG. 1,

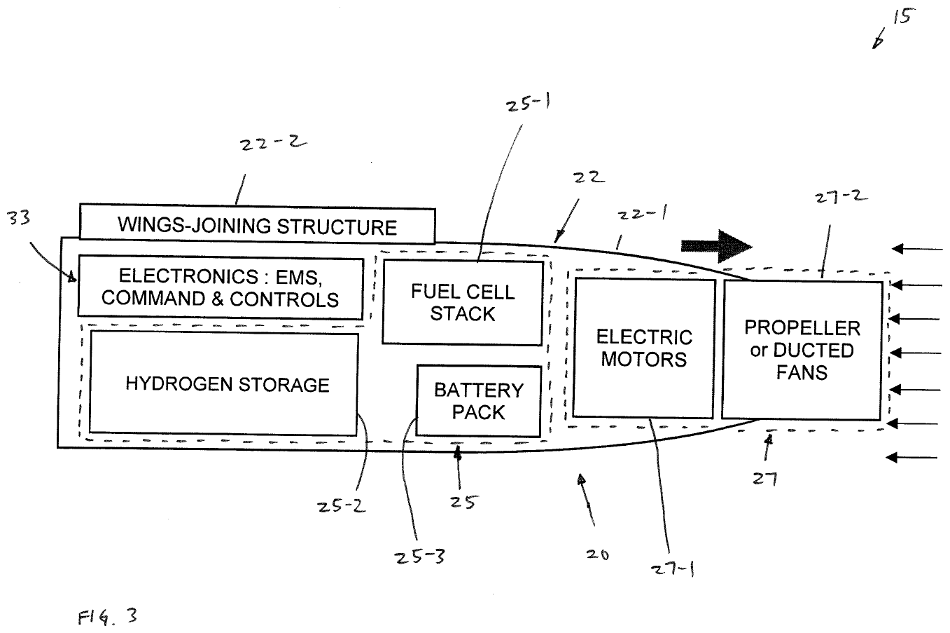

FIG. 3 illustrates a schematic block view of the electric energy pod of the aircraft of FIG. 1,

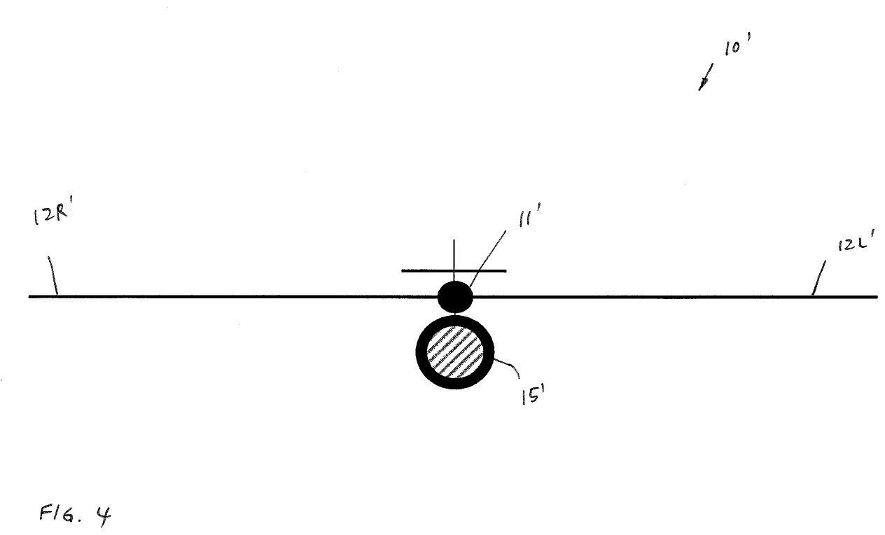

FIG. 4 illustrates a front cross-sectional view of a further improved aircraft that comprises the electric energy pod of FIG. 1, and

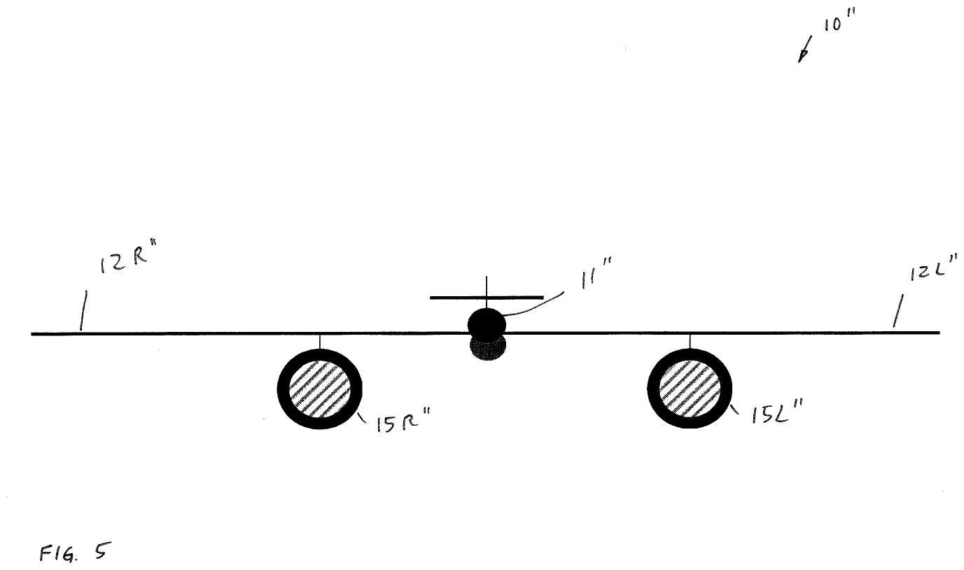

FIG. 5 illustrates a front cross-sectional view of another improved aircraft that comprises the electric energy pod of FIG. 1.

In the following description, details are provided to describe embodiments of the application. It shall be apparent to one skilled in the art, however, that the embodiments may be practised without such details.

Some embodiments have similar parts. The similar parts may have the same names or similar part reference numerals with an alphabet or prime symbol. The description of one similar part also applies by reference to another similar part, where appropriate, thereby reducing repetition of text without limiting the disclosure.

FIGS. 1 and 2 show an improved aircraft 10.

The aircraft 10 includes a fuselage 11 with two wings, namely a left-wing 12L and a right-wing 12R, a network of distributed energy nacelle modules 15 with a centralized energy management unit 18.

The distributed energy nacelle modules 15 are also called interchangeable external hydrogen fuel cell/battery hybrid electrical energy systems containment pods or distributed electric energy pods (DEEP).

Examples of the aircraft 10 include an electric unmanned aerial vehicle (UAV), an electric aircraft and an electric vertical take-off and landing (VTOL) flying passenger car, though the use of the distributed electric energy pod (DEEP) is not limited to these aircraft. The aircraft can travel underwater or in air.

The left-wing 12L and the right-wing 12R are attached to opposing sides of the fuselage 11.

The network of distributed energy nacelle modules 15 includes a first plurality 16L of the nacelle modules 15 and a second plurality 16R of the nacelle modules 15.

The first plurality 16L of nacelle modules 15 is positioned beneath the left-wing 12L of the aircraft 10 and is attached to a bottom part of the left-wing 12L. Similarly, the second plurality 16R of nacelle modules is positioned beneath the right-wing 12R of the aircraft 10 and is attached to a bottom part of the right-wing 12R.

In a general sense, the first plurality 16L of nacelle modules 15 can also be positioned on a top part of the left-wing 12L of the aircraft 10 or be provided as an integral part of the left-wing 12L that can be removed or detached quickly, without compromising overall aerodynamics of the aircraft 10. Similarly, the second plurality 16R of nacelle modules can also be positioned on a top part of the right-wing 12R of the aircraft 10 or be provided as an integral part of the right-wing 12R that can be removed or detached quickly, without compromising overall aerodynamics of the aircraft 10.

The centralized energy management unit 18 is electrically connected to the first plurality 16L and to the second plurality 16R of the nacelle modules 15. The centralized energy management unit 18 is placed in the fuselage 11.

As seen in FIG. 3, Each energy nacelle module 15 includes an energy storage and powering machine 20 and a nacelle 22. The nacelle 22 is also called a pod. The nacelle 22 encloses the energy storage and powering machine 20.

In detail, referring to the nacelle 22, it includes an enclosure 22-1 or housing and an aircraft joining structure 22-2.

The enclosure 22-1 is adapted for surrounding or enclosing the energy storage and powering machine 20. The enclosure 22-1 is also adapted or is streamlined to reduce wing drag for maximizing or improving aerodynamics performances.

The joining structure 22-2 is adapted for attaching the enclosure 22-1 to the wing 12L or 12R of the aircraft 10 such that the enclosure 22-1 is placed below the wing 12L or 12R.

The joining structures 22-2 are also adapted for a fast manual or robotics removal of the entire nacelle 22 from the aircraft 10 for an immediate exchange with a fully fuelled nacelle 22, for maintenance, or for the refilling of the energy storage and powering machine 20.

In a general sense, the joining structure 22-2 can also be adapted for attaching the enclosure 22-1 to the wing 12L or 12R of the aircraft 10 such that the enclosure 22-1 is on top of the wing 12L or 12R.

Referring to the energy storage and powering machine 20, it includes a power generation module 25, a propulsion module 27, a heat control module, and an electronics module 33. The heat control module is not shown in FIG. 3.

In detail, the power generation module 25 includes a Polymer Exchange Membrane fuel cell (PEMFC) stack 25-1 with an energy storage module 25-2 and/or a hybrid battery pack 25-3.

The energy storage module 25-2 includes hydrogen fuel in the form of pure gaseous hydrogen or pure liquid hydrogen, or hydrogen generating fuel. The hydrogen generating fuel refers to, though not limited to, a liquid or a solid chemical hydride storage element, such as magnesium hydride, for generating hydrogen. The energy storage module 25-2 is also called a hydrogen storage unit or a hydrogen generator unit with a function of storing and/or storing and generating hydrogen depending on the pod design.

The energy storage module 25-2 is connected to the fuel cell stack 25-1 such that the energy storage module 25-2 can be easily or quickly removed from the nacelle enclosure 22-1. After the hydrogen fuel or the hydrogen generating fuel of the energy storage module 25-2 is empty or spent, a user can easily or quickly replace the empty energy storage module 25-2 with a full energy storage module 25-2.

The energy storage module 25-2 is also adapted such that onboard refilling of the energy storage module 25-2 can be done. In other words, a user can add hydrogen fuel or add hydrogen generating fuel to the energy storage module 25-2 while the energy storage module 25-2 is placed inside the nacelle enclosure 22-1.

The hybrid battery pack 25-3 can include, though not limited to, a lithium polymer (LiPo) battery, a super-capacitor, or an air-breathing battery. The battery pack 25-3 is also adapted such that it can be removed from the nacelle enclosure 22-1. During maintenance, a user can replace the spent hybrid battery pack 25-3 with a full hybrid battery pack.

In a general sense, the hybrid battery pack 25-3 can also include other components, other chemical energy storage technologies, or combinations of other components and other chemical energy storage technologies.

Referring to the propulsion module 27, it includes an electric motor 27-1 with a propeller 27-2 or electric ducted fans (EDF).

Referring to the heat control module, it includes thermal isolation material, and ram air circulating devices for equipment cooling, and heat recovering systems for low outdoor temperature conditions. The ram air refers to the usage of airflow created by a moving object, such as an aircraft, to increase ambient pressure. This is often used to increase engine power.

Referring to the electronics module 33, it includes an embedded processor, health monitoring sensors, and an electrical and communication connectivity unit. The electrical and communication connectivity unit can refer to electrical signal wires, to electrical power wires, to means of connecting with avionics, to Controller Area Network (CAN) communication channels, or to command and control channels being connected to the centralized energy management unit 18.

The distributed energy nacelle modules 15 can be utilized in different ways depending on the size/airframe of the aircraft.

Certain large electrical aircraft would require the use of multiple energy nacelle modules 15 being arranged in parallel and other smaller aircraft may only need a single system. Hence, the nature/size of the aircraft plays a major role in determining the power output specifications for each of the distributed energy nacelle modules 15 and the followings are only examples for this disclosure, though this disclosure is not limited to the power and energy values provided below.

In one implementation, the energy nacelle module 15 is adapted to provide a predetermined power (W) and energy (Wh) combination each in the following range: configurations are fixed within a nominal power range from 0.1 watts (W) to 1000 kilowatts (kW) of nominal power, and from 1 watt-hour (Wh) to 10,000 kilowatt-hours (kWh) of stored energy.

In use, the multiple energy nacelle modules 15 serve to power and to move the aircraft 10.

The centralized energy management unit 18 provides an even energy distribution of energy supply by the different energy nacelle modules 15, wherein the aircraft 10 can function stably even if one or more energy nacelle modules 15 fail.

In detail, the centralized energy management unit 18 sends instructions to the different energy nacelle modules 15 for activating the respective energy nacelle modules 15.

The embedded processor of each electronics module 33 receives the instructions from the centralized energy management unit 18.

The embedded processor then sends corresponding instructions to the power generation module 25 for activating the power generation module 25.

The activated power generation module 25 later provides electrical energy to the propulsion module 27.

In particular, the electronics module 33 can activate the energy storage module 25-2 of the power generation module 25 to provide hydrogen gas to the fuel cell stack 25-1, wherein the fuel cell stack 25-1 uses the hydrogen gas to generate electrical energy and transmits the electrical energy to the electric motor 27-1 of the propulsion module 27.

The electronics module 33 can also activate the battery pack 25-3 to provide electrical energy to the electric motor 27-1 of the propulsion module 27.

The energised electric motor 27-1 then provides mechanical energy to turn the propeller 27-2 for moving the aircraft 10.

The centralized energy management unit 18 is also adapted to provide safety through active system health management. Put differently, the centralized energy management unit 18 is adapted to ensure safe and continuous power supply with redundant, automated and controlled distribution, and adapted to resolve emergency conditions. The centralized energy management unit 18 controls and manages energy from different energy sources of the power generation module 25. These energy sources can include solar panels. As an example, the centralized energy management unit 18 activates an energy system of one energy nacelle module 15 to provide power to a propeller and a motor of an aircraft. In a case of an issue with the energy system, the centralized energy management unit 18 can then activate a second energy system of another energy nacelle module 15 to provide power to the propeller and the motor.

In a special embodiment, the energy nacelle module 15 is adapted for connecting to additional external power sources, such as solar.

The embodiment provides a network of distributed electric energy sources that provides an enhanced distributed energy architecture for an aircraft or an unmanned aerial vehicle (UAV). The energy nacelle modules 15 can be distributed or placed on top or beneath wings of the aircraft or the UAV. The number and configurations of the energy nacelle modules 15 can be chosen based on specific requirements of the aircraft or the UAV.

The embodiment also provides a network of interchangeable distributed external hydrogen fuel cell/battery hybrid electrical energy systems containment pods that enables smart and efficient power generation architectures for different aircraft or unmanned aerial vehicles platforms, which in return yields an improved aircraft concept. The fuel cell/battery hybrid based distributed electric energy pods can be utilized as multiple systems in parallel that is multiple pods operated in parallel, or as a single powering system to move and power an electrically powered aircraft, or as a single system to move and power an unmanned aerial vehicle.

In a general sense, the energy nacelle module 15 can be configured for adding to existing or future aircraft fuselage to serve as an electric energy range extender unit.

FIG. 4 shows a further improved aircraft 10′, which is a variant of the aircraft 10 of FIG. 1.

The aircraft 10′ includes a fuselage 11′ with a left-wing 12L′ and with a right-wing 12R′, as well as an energy nacelle module 15′. The left-wing 12L′ and the right-wing 12R′ are attacked sides of the fuselage 11. The nacelle module 15′ is positioned beneath the fuselage 11′ of the aircraft 10′ and is attached to a bottom part of the fuselage 11′.

FIG. 5 shows another improved aircraft 10″, which is a variant of the aircraft 10 of FIG. 1.

The aircraft 10″ includes a fuselage 11″, a left-wing 12L″ with a nacelle module 15L″, and a right-wing 12R″ with a nacelle module 15R″.

The left-wing 12L″ and the right-wing 12R′ are attached sides of the fuselage 11″. The nacelle module 15L″ is positioned beneath the left-wing 12L″ and is attached to a bottom part of the left-wing 12L″. Similarly, the nacelle module 15LR″ is positioned beneath the right-wing 12R″ and is attached to a bottom part of the right-wing 12R″.

The embodiments can also be described with the following lists of features or elements being organized into an item list. The respective combinations of features, which are disclosed in the item list, are regarded as independent subject matter, respectively, that can also be combined with other features of the application.

### Items

1. A pod for moving a vehicle, the pod comprising
   an energy storage and powering machine and
   a nacelle, the nacelle comprising
      an enclosure for surrounding the energy storage and powering machine and
      a joining structure for attaching the enclosure to the vehicle,
   wherein the energy storage and powering machine comprises
      a power generation module,
      a propulsion module, which comprises an electric motor with a propeller module, and
      an electronics module for activating the power generation module to provide electrical energy to the electric motor, wherein the electric motor actuates the propeller module for moving the vehicle.
2. The pod according to item 1, wherein
   the power generation module comprises a fuel cell stack with an energy storage module and/or a hybrid battery pack.
3. The pod according to item 2, wherein
   the hybrid battery pack comprises a lithium polymer (LiPo) battery, a super-capacitor, or an air-breathing battery.
4. The pod according to one of items 1 to 3, wherein
   the propeller module comprises at least one propeller or at least one electric ducted fan (EDF).
5. The pod according to one of items 1 to 4, wherein
   the electronics module comprises a processor, at least one monitoring sensor, and/or an electrical and communication connectivity unit.
6. The pod according to one of items 1 to 5 further comprising
   a heat control module.
7. The pod according to item 6, wherein
   the heat control module comprises a thermal isolation material, and a ram air circulating device, and/or a heat recovering system.
8. The pod according to one of items 1 to 7 further comprising a connector for receiving energy from an external power source.
9. The pod according to item 8, wherein
   the external power source comprises a solar power source.
10. The pod according to item 8 or 9, wherein
   the external power source comprises a further pod.
11. A vehicle comprising
   two wings, and
   at least one pod according to one of items 1 to 10 being attached to the wing.
12. A vehicle comprising
   a body, and
   at least one pod according to one of items 1 to 10 being attached to the body.
13. The vehicle according to item 11 or 12 further comprising an energy management unit for activating the pod to provide electrical energy to a propulsion module of the pod.
14. A vehicle comprising
   two wings,
   a body,
   at least one first pod according to one of items 1 to 10, wherein the at least one first pod is attached to the wing, and
   at least one second according to one of items 1 to 10, wherein the at least one second pod is attached to the body.
15. The vehicle according to item 14 further comprising
   an energy management unit for
      activating the first pod to provide electrical energy to a first propulsion module of the first pod and
      activating the second pod to provide electrical energy to a second propulsion module of the second pod.
16. A method of providing electrical power to a vehicle, the method comprising
   attaching at least one pod to the vehicle, the pod containing a hydrogen fuel cell with a hybrid battery and a propulsion module, and
   activating at least one of the hydrogen fuel cell and a hybrid battery to provide electrical energy to the propulsion module.
17. The method according to item 16, wherein
   the attaching comprises attaching at least two pods to the vehicle.
18. The method according to item 17, wherein
   the activating is performed to provide an even distribution of electrical energy to the propulsion module of the pod.

Although the above description contains much specificity, this should not be construed as limiting the scope of the embodiments but merely providing an illustration of the foreseeable embodiments. The above-stated advantages of the embodiments should not be construed, especially as limiting the scope of the embodiments but merely to explain possible achievements if the described embodiments are put into practice. Thus, the scope of the embodiments should be determined by the claims and their equivalents, rather than by the examples given.

### REFERENCE NUMBERS

10 aircraft
11 fuselage
12L left-wing
12R right-wing
15 energy nacelle module
18 centralized energy management unit
16L first plurality of the nacelle modules
16R second plurality of the nacelle modules
20 energy storage and powering machine
22 nacelle
22-1 enclosure
22-2 aircraft joining structure
25 power generation module
25-1 fuel cell stack
25-2 energy storage module
25-3 hybrid battery pack
27 propulsion module
27-1 electric motor
27-2 propeller
33 electronics module
10′ aircraft
11′ fuselage
12L′ left-wing
12R′ right-wing
15′ energy nacelle module
10″ aircraft
11″ fuselage
12L″ left-wing
15L″ nacelle module
12R″ right-wing
15R″ nacelle module

1. A pod for moving a vehicle, the pod comprising
an energy storage and powering machine and
a nacelle, the nacelle comprising
an enclosure for surrounding the energy storage and powering machine and
a joining structure for attaching the enclosure to the vehicle,
wherein the energy storage and powering machine comprises
a power generation module,
a propulsion module, which comprises an electric motor with a propeller module, and
an electronics module for activating the power generation module to provide electrical energy to the electric motor, wherein the electric motor actuates the propeller module for moving the vehicle.

2. The pod according to claim 1, wherein
the power generation module comprises a fuel cell stack with an energy storage module and/or a hybrid battery pack.

3. The pod according to claim 2, wherein
the hybrid battery pack comprises a lithium polymer (LiPo) battery, a super-capacitor, or an air-breathing battery.

4. The pod according to claim 1, wherein
the propeller module comprises at least one propeller or at least one electric ducted fan (EDF).

5. The pod according to claim 1, wherein
the electronics module comprises a processor, at least one monitoring sensor, and/or an electrical and communication connectivity unit.

6. The pod according to claim 1 further comprising
a heat control module.

7. The pod according to claim 6, wherein
the heat control module comprises a thermal isolation material, and a ram air circulating device, and/or a heat recovering system.

8. The pod according to claim 1 further comprising a connector for receiving energy from an external power source.

9. The pod according to claim 8, wherein
the external power source comprises a solar power source.

10. The pod according to claim 8, wherein
the external power source comprises a further pod.

11. A vehicle comprising
two wings, and
at least one pod according to claim 1 being attached to the wing.

12. A vehicle comprising
a body, and
at least one pod according to claim 1 being attached to the body.

13. The vehicle according to claim 11 further comprising
an energy management unit for activating the pod to provide electrical energy to a propulsion module of the pod.

14. A vehicle comprising
two wings,
a body,
at least one first pod according to claim 1, wherein the at least one first pod is attached to the wing, and
at least one second according to claim 1, wherein the at least one second pod is attached to the body.

15. The vehicle according to claim 14 further comprising
an energy management unit for
activating the first pod to provide electrical energy to a first propulsion module of the first pod and
activating the second pod to provide electrical energy to a second propulsion module of the second pod.

16. A method of providing electrical power to a vehicle, the method comprising
attaching at least one pod to the vehicle, the pod containing a hydrogen fuel cell with a hybrid battery and a propulsion module, and
activating at least one of the hydrogen fuel cell and a hybrid battery to provide electrical energy to the propulsion module.

17. The method according to claim 16, wherein
the attaching comprises attaching at least two pods to the vehicle.

18. The method according to claim 17, wherein
the activating is performed to provide an even distribution of electrical energy to the propulsion module of the pod.
